(19) United States
(12) Patent Application Publication
(10) Pub. No.: US 2019/0010698 A1
(43) Pub. Date: Jan. 10, 2019

(54) IMPACT RESISTANT COMPOSITE WALLBOARD

(71) Applicant: TIMM BIERMAN, Sussex, WI (US)

(72) Inventor: TIMM BIERMAN, Sussex, WI (US)

(21) Appl. No.: 16/024,036

(22) Filed: Jun. 29, 2018

Related U.S. Application Data
(60) Provisional application No. 62/529,204, filed on Jul. 6, 2017.

(51) Int. Cl. E04C 2/26; E04B 2/00; B32B 13/12; B32B 27/32; B32B 27/30; B32B 3/12

(52) U.S. Cl. CPC E04C 2/26; E04C 2/46; B32B 13/12; B32B 2607/00; B32B 27/304; B32B 3/12; B32B 27/32

(57) ABSTRACT

A composite board is disclosed comprising a first layer of drywall coupled to a second backing layer comprising at least one of an HDPE or cellular PVC layer.

### RELATED APPLICATION

This application claims the benefit of co-pending U.S. Provisional Patent Application Ser. No. 62/529,204, filed 6 Jul. 2017.

### BACKGROUND OF THE INVENTION

Drywall & cement board for tile backing (wallboard) are commonly used products for walls in construction. A problem for both products is the ability to mount anything directly to them without providing supplemental backing or finding a wall framing stud. Typical items that are mounted to walls include safety grab bars in showers and around toilets, towel bars, toilet paper holders, cabinetry, handrails at stairs, closet interior systems, etc. Currently an installer either needs to layout and install wood blocks as backing at the areas where items are to be mounted, cover the entire wall with plywood or similar prior to installing wallboard, stagger anchors to conform to the concealed stud framing or use specialty “hollow” wall anchors to secure the item to the wallboard.

The performance characteristics provided by the composite product can only be achieved currently by providing supplemental blocking and/or backing to existing products which adds expense, requires more construction time and can decrease room size.

Gypsum drywall and cement board have favorable characteristics in construction & finishing of walls however both products have poor characteristics in impact resistance and anchor retention. The invention claimed here solves this problem.

### SUMMARY OF THE INVENTION

This product allows for the mounting of various items without needing supplemental blocking, backing or use of specialty hollow wall anchors. Gypsum drywall and cement board have favorable characteristics in construction & finishing of walls however both products have poor characteristics in impact resistance and anchor retention. The invention claimed here solves this problem.

A composite wallboard product is described herein. The composite product consists of a face layer of gypsum drywall or cement board bonded to a substrate layer of HDPE or cellular PVC plastic sheet.

This product allows for the favorable finishing characteristics of drywall & cement board to be utilized while providing the enhanced impact resistance and high anchor retention properties of the plastic sheet.

Manufactured composite panels are installed or typical wood or metal stud framing or furring. Due to the unique characteristics of the composite panel to allow the direct attachment of accessory items, the panel must be firmly attached to the stud framing with screws on a specific pattern (i.e. 8″ O.C.) in order to assure the panel neither becomes detached from the stud framing nor flexes excessively which could potentially damage the finish of wall. Panels are cut to fit the dimensions of the wall it is covering and cut-outs are made to accommodate typical items such as light switches, outlets, plumbing pipes, etc. Wall panels are finished in methods typical for the industry such as using drywall compound and joint tape to cover seams and screw heads. Finishes such as paint, tile, paneling, etc. can be applied to complete the wall construction. Accessory items such as grab bars, toilet paper or towel holders, etc. can be mounted directly to the wall without regard to location of studs or blocking using the manufacturers provided or specified anchors. Additionally an added benefit of the composite panel is that the plastic base layer portion of the panel provides outstanding impact resistance that the traditional drywall or cement board face layer lack.

Sheets of drywall, cement board or similar are bonded to a base layer of a plastic like sheet such as HDPE, cellular PVC or similar. The method of bonding the two products can be via adhesives, mastics, thermally fused or similar methods.

The invention can be used by installing the composite panel product to the stud framing of a house, commercial building or similar during initial construction or renovation. Once installed a variety or items such as grab bars or toilet paper holders can be mounted to the walls without the typical need for locating studs, blocking or using a specialty hollow wall anchor.

### BRIEF DESCRIPTION OF THE DRAWINGS

FIG. 1 is a perspective view of a composite material of the present invention;

FIG. 2 is a closeup view of a portion of the composite material of FIG. 1;

FIG. 3 is a perspective exploded view of the composite material of FIG. 1;

FIG. 4 is an enlarged exploded section view of the composite material of FIG. 3;

FIG. 5 is a perspective view of a typical, bathroom installation with grab bar and paper holder;

FIG. 6 is a top view of a typical bathroom installation of a drywall layer with a grab bar secured to wall studs;

FIG. 7 is a top view of a typical bathroom installation of a composite layer of the present invention with a grab bar;

FIG. 8 is a top view of a typical bathroom installation of a composite layer of the present invention with a toilet paper holder;

FIG. 9 is a side view of a cabinet installation of a composite layer of the present invention carrying a heavy cabinet;

FIG. 10 is a side view of a composite layer of the present invention showing impact resistance.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details way be changed, without departing from the invention, which is defined by the claims.

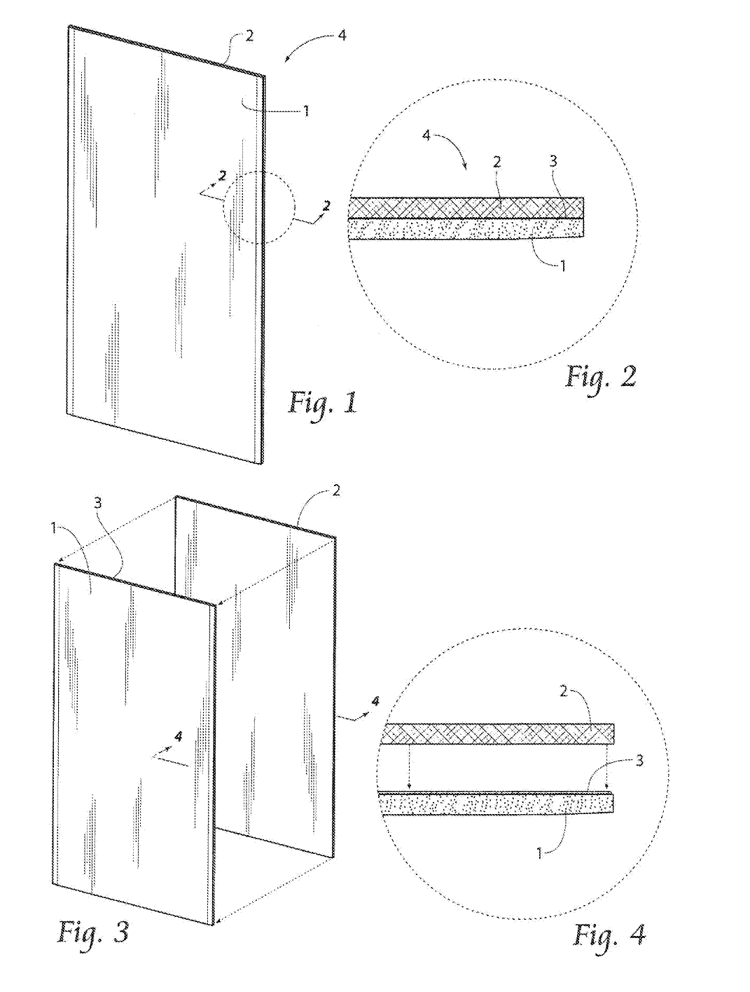

Referring now to FIGS. 1-4, a face layer 1 of gypsum drywall board, cement board is shown, coupled to a base layer 2 of HDPE, cellular PVC or similar. Adhesive 3 or mastic to is used to bond the face layer 1 to the base layer. Together, a composite panel 4 comprised of face layer 1 bonded to base layer 2 is formed.

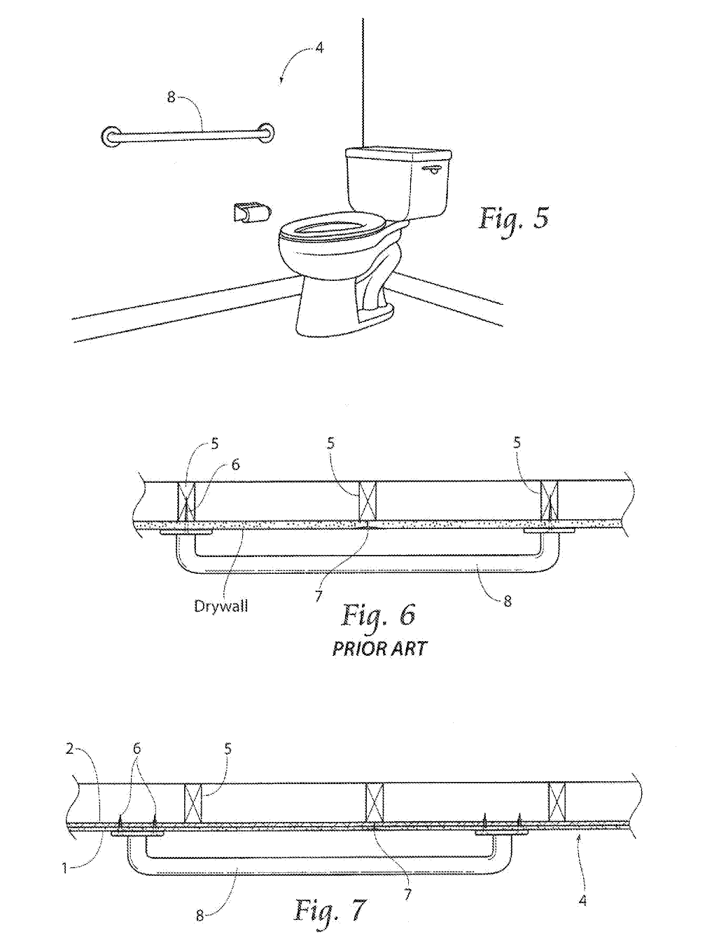

Referring now to FIG. 5, in use, a perspective view of a typical bathroom installation with grab bar and paper holder 5 is shown. As shown in FIG. 6, a top view of a typical prior art bathroom installation of a drywall layer with a grab bar 8 secured to wall studs 5 by screws 6 is shown. As is well known, it is useful if not necessary for proper securement that screws 6 enter studs 5. Further, edges 7 (Drywall compound and joint tape for finishing of gypsum drywall) of the drywall are appropriately spaced and secured onto studs 5. Spacing of the studs 5 is therefore very limiting, as the studs might not align with the intended mounting positions.

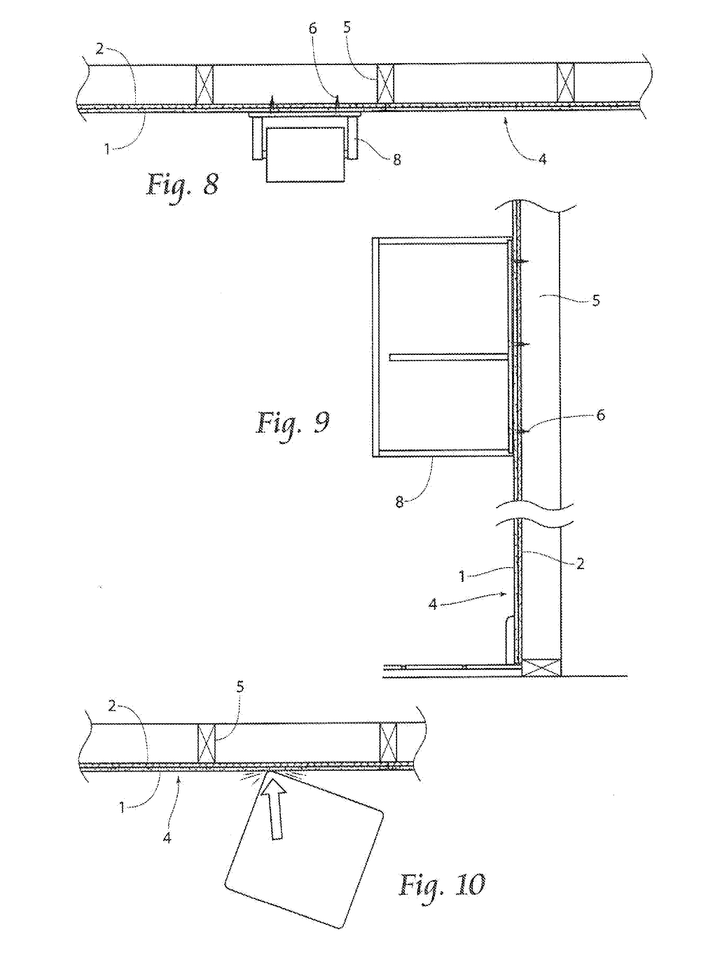

Referring now to FIG. 7 a top view of a typical bathroom installation of a composite layer 4 of the present invention with a grab bar 8 is shown. As can be seen, due to the construction of the composite layer 4, screws 6 are not necessarily required to be mounted to studs 5, as the composite 4 serves as an appropriate supporting structure for the grab bar 8, or toilet paper holder 8 as shown in FIG. 8.

The present invention can also secure items vertically such as a heavy cabinet 8 shown in FIG. 9. Referring now to FIG. 10, the present composite 4 achieves greater impact resistance as well.

A face layer of drywall or cement board (1) is bonded via adhesive (3) no the plastic sheet base layer (2) to create the composite panel (4). Panels (4) are attached to the plurality of framing members (5) via screw fasteners (6). Upon completion of assembling the panels (4) to the stud framing (5) walls can be finished using products standard to the industry, i.e. drywall compound and joint tape (7). Wall mounted accessories such as grab bars (8) can be fastened per manufacturers specifications directly to the composite panel (4).

A preferred embodiment of the invention is to attach the composite product to the stud framing with a screw fastener which has a smooth shaft from the head of the screw to the end of the threads equal in length to the thickness of the composite panel. The smooth shaft of the screw ensures the panel will lay flat against the stud framing and not be potentially held away from the stud by the threads engaging and locking in the plastic component layer.

A preferred embodiment of the invention is to print a grid of “ghost lines” on the face of the product 8″ on center each way (not shown). The purpose of the ghost lines is to provide a failsafe for the preferred centering of fasteners into the stud framing.

A preferred embodiment of the invention is to select a plastic sheet product specifically formulated when utilized in combination with the gypsum layer meets or exceeds the industry standards for the fire ratings of standard drywall of similar thicknesses. For example, ½″ drywall has a 30 minute rating and ⅝″ drywall has a 45 minute rating.

A preferred embodiment of the invention is to select a plastic sheet product, specifically formulated when utilized in combination with the gypsum layer which has minimal thermal expansion and contraction between the temperatures of 50° F. and 100° F.

A preferred embodiment of the invention is to select a gypsum sheet product specifically formulated when utilized in combination with the plastic layer that meets or exceeds the Noise Reduction Coefficient (NRC) and Sound Transmission Class (STC) of standard drywall of similar thicknesses when installed in equivalent assemblies. NTC & STC ratings of walls and ceilings are typically measured as an assembly of wallboard, framing and other items commonly used to reduce sound such as fiberglass insulation.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A composite board comprising a first layer of drywall coupled to a second backing layer comprising at least one of an HDPE or cellular PVC layer.
